(19) United States
(12) Patent Application Publication
(10) Pub. No.: US 2008/0319136 A1
(43) Pub. Date: Dec. 25, 2008

(54) Propylene-Ethylene Block Copolymer and Molded Article Thereof

(75) Inventors: Hideki Oshima, Bartlesville, OK (US); Takashi Sanada, Chiba (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited, Chuo-ku (JP)

(21) Appl. No.: 12/064,694

(22) PCT Filed: Aug. 29, 2006
(86) PCT No.: PCT/JP2006/017405

§ 371 Date: Mar. 20, 2008

(30) Foreign Application Priority Data
Aug. 30, 2005 (JP) 2005-248849

(51) Int. Cl. C08L 23/16

(52) U.S. Cl. 525/240

(57) ABSTRACT

A propylene-ethylene block copolymer comprising from 60 to 85% by weight of a polypropylene portion and from 15 to 40% by weight of a propylene-ethylene random copolymer portion and satisfying the requirements (1) and (2) defined below is provided. In addition, a molded article containing such a propylene-ethylene block copolymer is provided.

Requirement (1): the propylene-ethylene random copolymer portion comprises a propylene-ethylene random copolymer component (EP-A) and a propylene-ethylene random copolymer component (EP-B), the copolymer component (EP-A) having an intrinsic viscosity of not less than 4 dl/g but less than 8 dl/g and an ethylene content of from 20 to 60% by weight, and the copolymer component (EP-B) having an intrinsic viscosity of not less than 0.5 dl/g but less than 3 dl/g and an ethylene content of from 40 to 80% by weight.

Requirement (2): the propylene-ethylene block has a melt flow rate of from 5 to 120 g/10 min.

### TECHNICAL FIELD

The present invention relates to propylene-ethylene block copolymers and molded articles thereof. More particularly, the invention relates to propylene-ethylene block copolymers excellent in stiffness, moldability, toughness, appearance, impact resistance and heat resistance, and to molded articles thereof.

### BACKGROUND ART

Polypropylene, especially propylene-ethylene block copolymers are widely used in applications where stiffness and impact resistance are required, such as automotive interior or exterior materials and components of electric products.

For example, JP-A 9-48831 discloses, for the purpose of improving impact resistance, stiffness and moldability, a propylene-ethylene block copolymer composed of a homopolypropylene portion, a propylene-ethylene copolymer portion with a lower ethylene content having an intrinsic viscosity of from 2 to 5 dl/g and a propylene-ethylene copolymer portion with a higher ethylene content having an intrinsic viscosity of from 3 to 6 dl/g.

JP-A 2003-327642 discloses, for the purpose of improving stiffness, hardness and moldability and also improving balance between toughness and impact resistance at low temperatures, a propylene-ethylene block copolymer comprising a crystalline polypropylene portion and a propylene-ethylene random copolymer portion composed of a propylene-ethylene random copolymer having an intrinsic viscosity of not less than 1.5 dl/g but less than 4 dl/g and a propylene-ethylene random copolymer having an intrinsic viscosity of not less than 0.5 dl/g but less than 3 dl/g.

However, such known propylene-ethylene block copolymers have been desired to be further improved in stiffness, moldability, toughness, appearance and impact resistance and heat resistance.

Under such circumstances, the object of the present invention is to provide propylene-ethylene block copolymers excellent in stiffness, moldability, toughness, appearance, impact resistance and heat resistance, and to provide molded articles thereof.

### Disclosure of the Invention

The present invention relates to a propylene-ethylene block copolymer comprising from 60 to 85% by weight, based on the total amount of the propylene-ethylene block copolymer, of a polypropylene portion which is a propylene homopolymer or a copolymer of propylene with 1 mol % or less of comonomer selected from ethylene or α-olefins having 4 or more carbon atoms, and from 15 to 40% by weight, based on the total amount of the propylene-ethylene block copolymer, of a propylene-ethylene random copolymer portion having a weight ratio of propylene units to ethylene units of from 35/65 to 75/25, wherein the propylene-ethylene block copolymer satisfies the following requirements (1) and (2), and the invention also relates to a molded article thereof;

requirement (1): the propylene-ethylene random copolymer portion comprises a first propylene-ethylene random copolymer component (EP-A) and a second propylene-ethylene random copolymer component (EP-B), the first copolymer component (EP-A) having an intrinsic viscosity [η]_{EP-A} of not less than 4 dl/g but less than 8 dl/g and an ethylene content [(C2′)_{EP-A}] of from 20 to 60% by weight, and the second copolymer component (EP-B) having an intrinsic viscosity [η]_{EP-B} of not less than 0.5 dl/g but less than 3 dl/g and an ethylene content [(C2′ )_{Ep-B}] of from 40 to 80% by weight,

requirement (2): the propylene-ethylene block has a melt flow rate of from 5 to 120 g/10 min.

According to the present invention, it is possible to obtain propylene-ethylene block copolymers excellent in stiffness, moldability, toughness, appearance, impact resistance and heat resistance and molded articles thereof.

### Best Mode for Carrying Out the Invention

The propylene-ethylene block copolymer of the present invention includes from 60 to 85% by weight, based on the total amount of the propylene-ethylene block copolymer, of a polypropylene portion which is a propylene homopolymer or a copolymer of propylene with 1 mol % or less of comonomer selected from the group consisting of ethylene or α-olefins having 4 or more carbon atoms, and from 15 to 40% by weight, based on the total amount of the propylene-ethylene block copolymer, of a propylene-ethylene random copolymer portion having a weight ratio of propylene units to ethylene units is from 35/65 to 75/25.

When the content of the polypropylene portion is less than 60% by weight, the stiffness or hardness may be deteriorated or a sufficient moldability may not be obtained due to decrease in fluidity in a molten state. When the content of the polypropylene portion exceeds 85% by weight, the toughness or impact resistance may be deteriorated.

The polypropylene portion included in the propylene-ethylene block copolymer of the present invention is a polypropylene which is a propylene homopolymer or a copolymer of propylene with 1 mol % or less of comonomer selected from the group consisting of ethylene and α-olefins having 4 or more. The term “comonomer” as used herein refers to monomers other than propylene constituting the copolymer. The amount of monomer expressed by “1 mol % or less” means the ratio of the number of the structural units derived from the comonomers to the total number of the structural units constituting the copolymer.

Examples of the α-olefins having 4 or more carbon atoms include 1-butene, 1-hexene, 4-methyl-1-pentene, 1-octene, 1-decene, 1-tetradecene, and 1-octadecene. Preferable examples are α-olefins having from 3 to 8 carbon atoms, specific examples of which include 1-butene, 1-hexene, 4-methyl-1-pentene, and 1-octene. Particularly preferable α-olefins are 1-butene and 1-hexene. If the content of the comonomers exceeds 1 mol %, the stiffness, heat resistance or hardness may be deteriorated.

From the viewpoint of stiffness, heat resistance or hardness, the polypropylene portion included in the propylene-ethylene block copolymer of the present invention is preferably a propylene homopolymer, and more preferably is a propylene homopolymer having an isotactic pentad fraction, as calculated by ¹³C-NMR, of from 0.95 to 1. The isotactic pentad fraction is a fraction of propylene monomer units which are present at the center of an isotactic chain in the form of a pentad unit, in other words, the center of a chain in which five propylene monomer units are meso-bonded successively, in the polypropylene molecular chain as measured by a method reported in A. Zambelli et al., Macromolecules, 6, 925 (1973), namely, by use of ¹³C-NMR. It is noted that NMR absorption peaks are assigned according to the disclosure of Macromolecules, 8, 687 (1975). Specifically, the isotactic pentad fraction is measured as an area fraction of mmmm peaks in the entire peak area of methyl carbon ranges of a ¹³C-NMR spectrum. According to this method, the isotactic pentad fraction of an NPL standard substance, CRM No. M19-14 Polypropylene PP/MWD/2 available from NATIONAL PHYSICAL LABORATORY, Great Britain was measured to be 0.944.

From the viewpoint of the balance between the fluidity in a molten state and the toughness of a molded article, the polypropylene portion included in the propylene-ethylene block copolymer of the present invention preferably has an intrinsic viscosity [η]ₚ of 1.5 dl/g or less, and particularly preferably from 0.65 dl/g to 1.5 dl/g. The molecular weight distribution of the polypropylene portion, as determined by gel permeation chromatography (GPC), preferably is not less than 3 but less than 7, and more preferably from 3 to 5. The “molecular weight distribution” may be expressed as “Q value” or “Mw/Mn” in the art. Mw and Mn are a weight average molecular weight and a number average molecular weight, respectively, determined by GPC. Therefore, the molecular weight distribution is a ratio of the weight average molecular weight to the number average molecular weight as determined by GPC. In the present invention, the GPC measurement is conducted under the conditions given below and the “molecular weight distribution” is determined using a calibration curve produced by use of standard polystyrenes.

Measuring temperature: 140° C.

Solvent: o-Dichlorobenzene

The weight ratio of the propylene units to the ethylene units in the propylene-ethylene random copolymer portion contained in the propylene-ethylene block copolymer of the present invention is from 35/65 to 75/25. If the weight ratio of the propylene units to the ethylene units is out of this range, sufficient impact resistance may not be obtained. The weight ratio of the propylene units to the ethylene units is preferably within the range of from 40/60 to 70/30.

The propylene-ethylene random copolymer portion in the propylene-ethylene block copolymer of the present invention includes a first propylene-ethylene random copolymer component (EP-A) and a second propylene-ethylene random copolymer component (EP-B).

The first propylene-ethylene random copolymer component (EP-A) has an ethylene unit content [(C2′)_{EP-A}] of from 20 to 60% by weight. When the ethylene unit content [(C2′)_{EP-A}] is out of the aforesaid range, balance of mechanical properties, e.g., toughness and impact resistance may deteriorate. The ethylene unit content [(C2′)_{EP-A}] is preferably from 25 to 50, and more preferably from 35 to 48% by weight.

The first propylene-ethylene random copolymer component (EP-A) has an intrinsic viscosity [η]_{EP-A} of not less than 4 dl/g but less than 8 dl/g, and preferably not less than 5 dl/g but less than 8 dl/g. If the intrinsic viscosity [η]_{EP-A} is less than 4 dl/g, the stiffness or hardness may be reduced or the toughness or impact resistance may also be reduced. When the intrinsic viscosity [η]_{EP-A} is 8 dl/g or more, many hard spots may be formed in molded articles or, in a case where the combined content of the propylene-ethylene random copolymer portions is large, specifically, when the combined amount of the first and second propylene-ethylene random copolymer portions is greater than 40% by weight of the total amount of the propylene-ethylene block copolymer, the fluidity of the block copolymer may be reduced.

The second propylene-ethylene random copolymer component (EP-B) has an ethylene unit content [(C2′)_{EP-B}] of from 40 to 60% by weight. When the ethylene content [(C2′)_{EP-B}] is out of the aforesaid range, balance of mechanical properties, e.g., impact resistance at low temperatures may deteriorate. The ethylene unit content [(C2′)_{EP-B}] is preferably from 42 to 60% by weight, and more preferably from 45 to 60% by weight.

The second propylene-ethylene random copolymer component (EP-B) has an intrinsic viscosity [η]_{EP-B} of not less than 0.5 dl/g but less than 3 dl/g, and preferably not less than 1 dl/g but less than 3 dl/g. If the intrinsic viscosity [η]_{EP-B} is less than 0.5 dl/g, the stiffness or hardness may be reduced or the toughness or impact resistance may also be reduced. If the intrinsic viscosity [η]_{EP-B} is 3 dl/g or more, the toughness or impact resistance may be reduced. In a case where the amount of the propylene-ethylene random copolymer portions is large, specifically, when the combined amount of the first and second propylene-ethylene random copolymer portions is greater than 40% by weight of the total amount of the propylene-ethylene block copolymer, the fluidity of the block copolymer may be reduced.

The ethylene unit content of a propylene-ethylene copolymer can be determined by NMR analysis, which is disclosed in detail in the Example section.

The content of a first propylene-ethylene random copolymer component (EP-A) and the content of a second propylene-ethylene random copolymer component (EP-B) in a propylene-ethylene block copolymer can be determined by calorimetric analysis using DSC in which a polymer composed of the polypropylene portion of the propylene-ethylene block copolymer, which polymer can be obtained by preparing the polypropylene portion and then sampling, a polymer composed of the polypropylene portion and the copolymer component (EP-A), which polymer can be obtained by preparing the polypropylene portion and the copolymer component (EP-A) and then sampling, and the propylene-ethylene block copolymer, respectively. In other words, by determining the amount of the heat of fusion of each of the polymer composed of the polypropylene portion of the propylene-ethylene block copolymer, the polymer composed of the propylene portion and the copolymer portion (EP-A), and the propylene-ethylene block copolymer by calorimetric analysis using DSC, the contents of the copolymer portion (EP-A) and the copolymer portion (EP-B) can be determined.

The content of the first propylene-ethylene random copolymer component (EP-A) or the second propylene-ethylene random copolymer component (EP-B) can be determined also based on the amounts of elements (e.g., magnesium and silicon) which were contained in the polymerization catalyst and which remain in the polymer. Specifically, the contents of the copolymer component (EP-A) and the copolymer component (EP-B) can be determined by quantitatively determining the contents of the catalyst-derived specified elements contained in each of the polymer composed of the polypropylene portion of the propylene-ethylene block copolymer, the polymer composed of the polypropylene portion and the copolymer component (EP-A), and the propylene-ethylene block copolymer, respectively.

The ethylene unit contents [(C2′)_{EP-A}] and [(C2′)_{EP-B}] can be determined based on the ethylene unit content, determined by NMR analysis, of each of the polymer composed of the polypropylene portion of the propylene-ethylene block copolymer, the polymer composed of the polypropylene portion and the copolymer component (EP-A), and the propylene-ethylene block copolymer, and on the contents of the copolymer component (EP-A) and the copolymer component (EP-B).

The propylene-ethylene block copolymer of the present invention has a melt flow rate (henceforth, MFR) of from 5 to 120 g/10 min, and preferably from 10 to 100 g/10 min. When the MFR is less than 5 g/10 min, the moldability may deteriorate or the effect of preventing the occurrence of flow marks may be insufficient; whereas when it is greater than 120 g/10 min, the impact resistance may be reduced. The MFR of a propylene-ethylene block copolymer is measured at a measuring temperature of 230° C. and a load of 2.16 kgf in accordance with the method provided in JIS K6758.

The propylene-ethylene block copolymer of the present invention can be produced by conventionally known processes using conventionally known polymerization catalysts and conventionally known polymerization methods.

Examples of polymerization catalysts which can be used include catalyst systems composed of (a) solid catalyst component including magnesium, titanium, halogen and an electron donor as essential components, (b) an organoaluminum compound and (c) electron donating component. Methods for preparing such catalysts are disclosed in detail in JP-A 1-319508, JP-A7-216017, JP-A10-212319, JP-A2004-182876, etc.

Examples of polymerization methods which can be used include bulk polymerization, solution polymerization, slurry polymerization, and vapor phase polymerization. These polymerization methods may be conducted either in a batch system or in a continuous system. Any combinations thereof are also available.

The propylene-ethylene block copolymer can be produced, more concretely by a polymerization method conducted by use of a polymerization apparatus including at least three polymerization vessels arranged in series, in the presence of an aforesaid catalyst system composed of (a) a solid catalyst component, (B) an organoaluminium compound and (c) an electron donating component as shown below:

(1) a polymerization process in which a polypropylene portion is produced, the polypropylene portion is then transferred to the next polymerization vessel and a first propylene-ethylene random copolymer component (EP-A) is produced in the polymerization vessel, the copolymer component (EP-A) and the aforesaid polypropylene portion are subsequently transferred to the next polymerization vessel and a second propylene-ethylene random copolymer portion (EP-B) is produced in the polymerization vessel continuously;

(2) a polymerization process in which a polypropylene portion is produced, the polypropylene portion is then transferred to the next polymerization vessel and a second propylene-ethylene random copolymer portion (EP-B) is produced in the polymerization vessel, the copolymer component (EP-B) and the aforesaid polypropylene portion are subsequently transferred to the next polymerization vessel and a first propylene-ethylene random copolymer component (EP-A) is produced in the polymerization vessel continuously.

From industrial and economic points of view, continuous vapor phase polymerization is preferred.

The amount of (a) the solid catalyst component, (b) the organoaluminum compound and (c) the electron donating component used in the aforementioned polymerization processes and the method for feeding the catalyst components into polymerization vessels may be determined appropriately.

The polymerization temperature is typically from −30 to 300° C., and preferably from 20 to 180° C. The polymerization pressure is typically from normal pressure to 10 MPa, and preferably from 0.2 to 5 MPa. As a molecular weight regulator, for example, hydrogen can be used.

In the production of the propylene-ethylene block copolymer of the present invention, preliminary polymerization may be conducted prior to the polymerization (main polymerization). One example of the method of the preliminary polymerization is a method which is carried out in a slurry state using a solvent while feeding a small amount of propylene in the presence of (a) a solid catalyst component and (b) an organoaluminum compound.

In use of the propylene-ethylene block copolymer of the present invention, other macromolecular materials and various additives may be added to the block copolymer of the present invention.

Examples of such macromolecular materials include elastomers. Examples of the additives include antioxidants, UV absorbers, inorganic fillers and organic fillers.

The propylene-ethylene block copolymer of the present invention can be fabricated into molded articles by appropriate molding techniques. It is particularly suitable for injection molding. Preferable examples of injection molded articles to be obtained from the propylene-ethylene block copolymer of the present invention include automotive components, such as door trims, pillars, instrument panels and bumpers.

### EXAMPLES

The present invention is described below with reference to examples.

First, methods for measuring physical properties of polymers used in Examples are described below.

(1) Intrinsic Viscosity (unit: dl/g)

Reduced viscosities were measured at three concentrations of 0.1, 0.2 and 0.5 g/dl using a Ubbelohde's viscometer. The measurement was carried out at a temperature of 135° C. using Tetralin as solvent. The intrinsic viscosities were calculated by a calculation method described in “Kobunshi Yoeki (Polymer Solution), Kobunshi Jikkengaku (Study of Polymer Experiment) Vol. 11” page 491 (published by Kyoritsu Shuppan Co., Ltd., 1982), namely, by an extrapolation method including plotting reduced viscosities against concentrations and extrapolating the concentration in zero.

### (1-1) Intrinsic Viscosity of Propylene-Ethylene Block Copolymer

### (1-1a) Intrinsic Viscosity of Polypropylene Portion [η]_{P}

The intrinsic viscosity [η]_{P} of the polypropylene portion was determined by the method described in (1) above using some polymer powder sampled from a polymerization vessel just after the polymerization reaction for the generation of the polypropylene portion during the production of the propylene-ethylene block copolymer.

### (1-1b) Intrinsic Viscosity of Propylene-Ethylene Random Copolymer [η]_{EP}

The intrinsic viscosity of the crystalline polypropylene portion [η]_{P} and the intrinsic viscosity of the propylene-ethylene block copolymer [η]_{T} are measured by the method described in (1) above. Then, the intrinsic viscosity of the propylene-ethylene random copolymer portion [η]_{EP} is determined from the equation provided below by use of a weight ratio X of the propylene-ethylene random copolymer portion to the propylene-ethylene block copolymer. The X was determined by the measuring method (3) described below:

[η]_{EP}=[η]_{T}/X−(1/X−1)[η]_{P}
[η]_{P}: the intrinsic viscosity (dl/g) of apolypropylene portion,
[η]_{T}: Intrinsic viscosity (dl/g) of the entire portion of propylene-ethylene block copolymer

In the case where the propylene-ethylene random copolymer portion is a propylene-ethylene random copolymer portion is obtained by two-stage polymerization, the intrinsic viscosity [η]_{EP-1} of the first copolymer component (EP-1) generated in the first stage, the intrinsic viscosity [η]_{EP-2} of the second copolymer component (EP-2) generated in the second stage, and the intrinsic viscosity [η]_{EP} of the propylene-ethylene random copolymer portion including the copolymer component (EP-1) and the copolymer component (EP-2) were determined by the following methods, respectively.

1) [η]_{EP-1}

After producing a copolymer component (EP-1) in the 1st stage, the intrinsic viscosity ([η]₍₁₎) of a sample taken from the polymerization vessel, and then the intrinsic viscosity [η]_{EP-1} of the copolymer component (EP-1) of the 1st stage was determined in the same way as (1-1b) above.

[η]_{EP-1}=[η]₍₁₎/X₍₁₎−(1/X₍₁₎−1)[η]_{P},
[η]_{P}: the intrinsic viscosity (dl/g) of apolypropylene portion,
[η]₍₁₎: the intrinsic viscosity (dl/g) of the entire portion of an intermediate block copolymer after the preparation of the copolymer component (EP-1),
X₍₁₎: the weight ratio of the copolymer component (EP-1) to the entire portion of the intermediate block copolymer after the preparation of the copolymer component (EP-1).

2) [η]_{EP}

The intrinsic viscosity [η]_{EP} of a propylene-ethylene random copolymer portion included in the propylene-ethylene block copolymer including the copolymer components (EP-1) and (EP-2) is determined in the same way as (1-1b) above.

[η]_{EP}=[η]_{T}/X−(1/X−1)[η]_{P}
[η]_{P}: the intrinsic viscosity (dl/g) of a polypropylene portion,
[η]_{T}: Intrinsic viscosity (dl/g) of the entire portion of the propylene-ethylene block copolymer
X: the weight ratio of the propylene-ethylene random copolymer portion to the entire portion of the propylene-ethylene block copolymer.

3) [η]_{EP-2}

The intrinsic viscosity [η]_{EP-2} of a copolymer component (EP-2) produced in the 2nd stage was determined from the intrinsic viscosity [η]_{EP} of a propylene-ethylene random copolymer portion in a propylene-ethylene block copolymer, the intrinsic viscosity [η]_{EP-1} of a copolymer portion (EP-1) of the 1st stage, and their weight ratios.

[η]_{EP-2}=([η]_{EP}×X−[η]_{EP-1}×X₁)/X₂,
X₁: the weight ratio of the copolymer component (EP-1) to the entire portion of the propylene-ethylene block copolymer,

X₁=(X₍₁₎−X×X₍₁₎)/(1−X₍₁₎),
X₂: the weight ratio to the copolymer component (EP-2) to the entire portion of the propylene-ethylene block copolymer,

X₂=X−X₁.

(2-1) Ethylene Unit Content [(C2′)_{EP}] of Propylene-Ethylene Random Copolymer Portion included in Propylene-Ethylene Block Copolymer

These values are determined on the basis of a 13C-NMR spectrum measured under the conditions given below, according to the report of Kakugo, et al. (Macromolecules, 15, 1150-1152 (1982)). In a test tube having a diameter of 10 mm, about 200 mg of a propylene-ethylene block copolymer was dissolved uniformly in 3 ml of o-dichlorobenzene to yield a sample solution, which was measured for its ¹³C-NMR spectrum under the following conditions:

measurement temperature: 135° C.,

pulse repeating time: 10 seconds,

pulse width: 45°, and

the number of integration: 2500.

### (2-2) Ethylene Unit Content [(C2′)_{EP-1}] of the 1st Copolymer Component (EP-1) Generated in the 1st Step Included in Propylene-Ethylene Block Copolymer

The ethylene unit content [(C2′)_{EP-1}] of the 1st copolymer component (EP-1) generated in the 1st step included in the propylene-ethylene block copolymer was determined in the same way as the ethylene unit content [(C2′)_{EP}] of a propylene-ethylene random copolymer portion contained in a propylene-ethylene block copolymer by using a sample taken out from a polymerization vessel after generating the copolymer component (EP-1) of the 1st stage instead of a propylene-ethylene block copolymer.

### (2-3) Ethylene Unit Content [(C2′)_{EP-2}] of the 2nd Copolymer Component (EP-2) Generated in the 2nd Stage Contained in Propylene-Ethylene Block Copolymer

The ethylene unit content [(C2′)_{EP-2}] was determined from the ethylene unit content [(C2′)_{EP}] of the propylene-ethylene random copolymer portion, the ethylene unit content [(C2′)_{EP-1}] of the lst copolymer component (EP-1) generated in the 1st stage contained in the propylene-ethylene block copolymer, the weight ratio X₁ of the copolymer component (EP-1) to the entire portion of the propylene-ethylene block copolymer, and the weight ratio X₂ of the copolymer component (EP-2) to the entire portion of the propylene-ethylene block copolymer.

[(C2′)_{EP-2}]=([(C2′)_{EP}]−[(C2′)_{EP-1}]×(X₁/(X₁+X₂)))×(X₁+X₂)/(X₂/)

### (3) Weight Ratio X of Propylene-Ethylene Random Copolymer Portion to the Entire Portion of Propylene-Ethylene Block Copolymer

The weight ratio Xp of the polymer generated in the step of polymerization to a polypropylene portion, the weight ratio X₁ of the copolymer component (EP-1) generated in the step of polymerization to the copolymer component (EP-1), and the weight ratio X₂ of the copolymer component (EP-2) generated in the step of polymerization to the copolymer component (EP-2) were determined from the following equations.

Xₚ=ΔH₂/ΔHₚ

X₁=(ΔHₚ/ΔH₁−1)×ΔH₂/ΔHₚ

X₂=1−Xₚ−X₁.
ΔHₚ: The amount of the heat of fusion (J/g) of the polymer after the step of polymerization to the polypropylene portion
ΔH₁: The amount of the heat of fusion (J/g) of the polymer after the step of polymerization to the copolymer component (EP-1)
ΔH₂: The amount of the heat of fusion (J/g) of the polymer after the step of polymerization to the copolymer component (EP-2)

In the production of the propylene-ethylene block copolymers used in the following Examples, a polypropylene portion was prepared first, and subsequently a component corresponding to the “second propylene-ethylene random copolymer component (EP-B)” was prepared, and then a component corresponding to the “first propylene-ethylene random copolymer component (EP-A)” was prepared. Therefore, [(C2′)_{EP-2}], [(C2′)_{EP-1}], [η]_{EP-2} and [η]_{EP-1} correspond to [(C2′)_{EP-A}], [(C2′)_{EP-B}], [η]_{EP-A}, and [η]_{EP-B}, respectively.

(4) Melt Flow Rate (MFR) (Unit: g/10 min)

The MFR is measured in accordance with the method provided in JIS K6758. The measurement was carried out at a measuring temperature of 230° C. and a load of 2.16 kgf, unless otherwise stated.

### (5) Flexural Modulus (FM) (Unit: MPa)

In accordance with ASTM D790, an elastic modulus at 23° C. was measured by use of a 3.2 mm thick specimen produced by injection molding.

(6) IZOD Impact Strength (Unit: kJ/m²)

In accordance with JIS K-7110, Izod impact strengths at 23° C. and −30° C. were measured by use of specimens (3.2 mm thick) which had been produced by injection molding and then notched.

### (7) Elongation at Break (UE) (Unit: %)

In accordance with ASTM D638, an elastic modulus at 23° C. was measured at a tensile rate of 20 mm/min by use of a 3.2 mm thick specimen produced by injection molding.

### (8) Die Swell

The die swell was measured using a Capillograph 1B manufactured by Toyo Seiki Seisaku-Sho Co., Ltd. under the conditions given below.

Measurement temperature: 220° C.

L/D: 40

Shear rate: 2.432×10³ sec⁻¹

JP-A 2005-146160, etc. disclose that the higher the die swell, the less probably flow marks are formed and the better the appearance becomes.

### [Preparation of Solid Catalyst Component]

The solid catalyst component used for the production of the propylene-ethylene block copolymer of the present invention was produced in the same manner as Example 1 (1), (2) of JP-A 2003-105020, except for washing a product with 105° C. toluene six times before drying it under reduced pressure.

### [Production of Propylene-Ethylene Block Copolymer (BCPP1) as Propylene-Based Polymer]

### [Preliminary Polymerization]

Into a SUS autoclave having a capacity of 3 L and equipped with a stirrer, 1.5 L of n-hexane which had been fully dehydrated and degassed, 30.0 mmol of triethylaluminum, 3.0 mmol of cyclohexylethyldimethoxysilane and 16 g of the solid catalyst component were added. Preliminary polymerization was conducted by introducing 16 g of propylene continuously over about 30 minutes while the temperature in the autoclave was kept at about 10° C. Then, the preliminarily polymerized slurry was transferred to a SIS autoclave having a capacity of 200 L and equipped with a stirrer, and 80 L of liquid butane was added thereto to yield a slurry of a preliminarily polymerized catalyst component.

### [Polymerization Step (1)]

Five reactors including three vessel-type reactors with stirrers having capacities of 40 L (liquid level=18 L), 200 L (liquid level=50 L) and 200 L (liquid level=50 L), respectively (for the first stage) and two fluidized bed type vapor phase reactors with stirrers each having a capacity of 1 m³ (for the second stage) were arranged in series. A process which includes production of a polypropylene portion in the first to third reactors, and production of propylene-ethylene random copolymer portions in the fourth and fifth reactors (namely, production of a copolymer component (EP-B) in the fourth reactor and production of a copolymer component (EP-A) in the fifth reactor) was carried out in a manner that polymerization was performed continuously by continuously transferring a polymer produced in each reactor to the next downstream reactor without conducting deactivation of the catalyst.

In the first through third reactors, continuous polymerization was conducted (polymerization time: 0.3/0.5/0.5 (hours)) by introducing 40 (mmol/h) of triethylaluminum, 6 (mmol/h) of cyclohexylethyldimethoxysilane and the aforementioned preliminarily polymerized slurry as a solid catalyst component at a rate of 1.03 (g/h) into the first reactor while adjusting the polymerization temperature to 73/70/67 (° C.), polymerization pressures to 4.6/4.0/3.8 (MPa), the amount of propylene introduced to 25/15/0 (kg/H), and the amount of hydrogen introduced to 300/70/0 (NL/h).

### [Polymerization Step (2)]

The discharged polymer was continuously introduced into a fluidized bed type vapor phase reactor, i.e. the fourth reactor of the second stage, without being deactivated. Continuous polymerization was continued for 3.4 hours while introducing 24 (mmol/h) of tetraethoxysilane (TES) under continuous introduction of propylene, ethylene and hydrogen such that the poymerization temperature and the polymerization pressure could be kept at 70(° C.) and 1.6 (MPa), respectively, and the hydrogen concentration and the ethylene concentration in the vapor phase could be kept at 6.5 (vol %) and 42.2 (vol %), respectively.

### [Polymerization Step (3)]

The discharged polymer was continuously introduced into a fluidized bed type vapor phase reactor, i.e. the fifth reactor of the second stage, without catalyst deactivation. Continuous polymerization was continued for 3.0 hours under continuous introduction of propylene, ethylene and hydrogen such that the polymerization temperature and the polymerization pressure could be kept at 70(° C.) and 1.4 (MPa), respectively, and the hydrogen concentration and the ethylene concentration in the vapor phase could be kept at 0.41 (vol %) and 27.9 (vol %), respectively. As the result, a propylene-ethylene block copolymer was obtained. The polymerization activity was 18.2 (kg/h). The analysis results of the resulting propylene-ethylene block copolymer are shown in Table 1.

### [Production of Propylene-Ethylene Block Copolymer (BCPP2)]

Polymerization was carried out in the same manner as the production of BCPP1, except for changing the continuous polymerization time of polymerization step (2) from 3.4 hours to 2.8 hours, and in polymerization step (3), changing the hydrogen concentration of the vapor phase from 0.41 (vol %) to 0.20 (vol %), the ethylene concentration from 27.9 (vol %) to 28.6 (vol %), and the continuous polymerization time from 3.0 hours to 2.5 hours. The polymerization activity was 21.9 (kg/h). The analysis results of the resulting propylene-ethylene block copolymer are shown in Table 1.

### [Production of Propylene-Ethylene Block Copolymer (BCPP3)]

Polymerization was carried out in the same manner as the production of BCPP1, except for, in polymerization step (2), changing the hydrogen concentration of the vapor phase from 6.5 (vol %) to 7.0 (vol %), the ethylene concentration from 42.2 (vol %) to 49.9 (vol %) and the continuous polymerization time from 3.4 hours to 3.2 hours, and in polymerization step (3), changing the hydrogen concentration of the vapor phase from 0.41 (vol %) to 0.40 (vol %), the ethylene concentration from 27.9 (vol %) to 28.3 (vol %) and the continuous polymerization time from 3.0 hours to 2.9 hours. The polymerization activity was 18.9 (kg/h). The analysis results of the resulting propylene-ethylene block copolymer are shown in Table 1.

### [Production of Propylene-Ethylene Block Copolymer (BCPP4)]

Polymerization was carried out in the same manner as the production of BCPP1, except for changing the continuous polymerization time of polymerization step (2) from 3.4 hours to 2.9 hours, and in polymerization step (3), changing the hydrogen concentration of the vapor phase from 0.41 (vol %) to 1.6 (vol %), the ethylene concentration from 27.9 (vol %) to 28.1 (vol %), and the continuous polymerization time from 3.0 hours to 2.6 hours. The polymerization activity was 21.2 (kg/h). The analysis results of the resulting propylene-ethylene block copolymer are shown in Table 1.

### [Production of Propylene-Ethylene Block Copolymer (BCPP5)]

Polymerization was carried out in the same manner as the production of BCPP1, except for, in the first through third reactors in polymerization step (1), changing the polymerization temperature from 73/70/67 (° C.) to 72/71/64 (° C.), the amount of hydrogen introduced from 300/70/0 (NL/h) to 300/120/20 (NL/h), in polymerization step (2), changing the hydrogen concentration of the vapor phase from 6.5 (vol %) to 3.5 (vol %), the ethylene concentration from 42.2 (vol %) to 49.6 (vol %) and the continuous polymerization time from 3.4 hours to 2.9 hours, and in polymerization step (3), changing the hydrogen concentration of the vapor phase from 0.41 (vol %) to 1.60 (vol %), the ethylene concentration from 27.9 (vol %) to 28.0 (vol %) and the continuous polymerization time from 3.0 hours to 2.7 hours. The polymerization activity was 20.5 (kg/h). The analysis results of the resulting propylene-ethylene block copolymer are shown in Table 1.

### [Production of Propylene-Ethylene Block Copolymer (BCPP6)]

Polymerization was carried out in the same manner as the production of BCPP1, except for, in the first through third reactors in polymerization step (1), changing the polymerization temperature from 73/70/67 (° C.) to 72/71/64 (° C.), the amount of hydrogen introduced from 300/70/0 (NL/h) to 300/120/20 (NL/h), in polymerization step (2), changing the hydrogen concentration of the vapor phase from 6.5 (vol %) to 3.6 (vol %), the ethylene concentration from 42.2 (vol %) to 50.8 (vol %) and the continuous polymerization time from 3.4 hours to 3.6 hours, and in polymerization step (3), changing the hydrogen concentration of the vapor phase from 0.41 (vol %) to 0.34 (vol %), the ethylene concentration from 27.9 (vol %) to 28.3 (vol %) and the continuous polymerization time from 3.0 hours to 3.4 hours. The polymerization activity was 16.0 (kg/h). The analysis results of the resulting propylene-ethylene block copolymer are shown in Table 1.

TABLE 1

| | BCPP1 | BCPP2 | BCPP3 | BCPP4 | BCPP5 | BCPP6 |
|---|---|---|---|---|---|---|
| MFR | 31.9 | 18.0 | 22.2 | 25.3 | 53.8 | 32.8 |
| (g/10 min) | | | | | | |
| Poly- | | | | | | |
| propylene | | | | | | |
| portion | | | | | | |
| Content (wt %) | 73.5 | 66.7 | 69.4 | 66.8 | 70.3 | 81.0 |
| [η]_{P} (dl/g) | 0.90 | 0.90 | 0.90 | 0.90 | 0.87 | 0.87 |
| Propylene- | | | | | | |
| ethylene | | | | | | |
| random | | | | | | |
| copolymer | | | | | | |
| portion | | | | | | |
| Content (wt %) | 26.5 | 33.3 | 30.6 | 33.2 | 29.7 | 19.0 |
| Component | | | | | | |
| (EP-A) | | | | | | |
| Content (wt %) | 9.8 | 11.3 | 9.7 | 10.4 | 6.7 | 4.0 |
| [η]_{EP-A} (dl/g) | 5.1 | 6.2 | 5.6 | 3.4 | 3.3 | 6.2 |
| [(C′2)_{EP-A}] | 46 | 38 | 45 | 39 | 33 | 38 |
| (wt %) | | | | | | |
| Component | | | | | | |
| (EP-B) | | | | | | |
| Content (wt %) | 16.7 | 22.0 | 20.9 | 22.8 | 23.0 | 15.0 |
| [η]_{EP-B} (dl/g) | 2.6 | 2.4 | 2.7 | 2.6 | 3.5 | 3.4 |
| [(C′2)_{EP-B}] | 54 | 54 | 59 | 55 | 63 | 63 |
| (wt %) | | | | | | |

### EXAMPLE 1

### Preparation of Injection Molded Article

To 100 parts by weight of BCPP1, 0.05 parts by weight of calcium stearate (produced by NOF Corp.), 0.10 parts by weight of 3,9-bis[2-{3-(3-tert-butyl-4-hydroxy-5-methylphenyl) propionyloxy}-1,1-dimethylethyl]-2,4,8,10-tetraoxaspiro [5.5]undecane (SUMILIZER GA80, produced by Sumitomo Chemical Co., Ltd.), and 0.20 parts by weight of 6-[3-(3-tert-butyl-4-hydroxy-5-methylphenyl) propoxy]-2,4,6,8,10-tetra-tert-butyldibenz[d,f][1.3.2] dioxaphosphepine (SUMILIZER GP, produced by Sumitomo Chemical Co., Ltd.) as stabilizers were added, followed by pelletization using a twin screw extruder (TEM 50A produced by Toshiba Machine Co., Ltd., cylinder temperature=150° C., a metal fiber sintered filter NF14N was included as a screen pack). Some of the pellets obtained were injection molded by an injection molding machine (IS100EN produced by Toshiba Machine Co., Ltd., cylinder temperature=200° C.) into specimens. The physical properties of the specimens were measured. The residence time of the molding material in the cylinder of the injection molding machine was not longer than 2 minutes. In addition, a die swell was measured using some of the pellets. The results are shown in Table 2.

### EXAMPLE 2

Specimens were prepared in the same manner as Example 1, except for using BCPP2 instead of BCPP1. Then, their physical properties were measured. The results are shown in Table 2.

### EXAMPLE 3

Specimens were prepared in the same manner as Example 1, except for using BCPP3 instead of BCPP1. Then, their physical properties were measured. The results are shown in Table 2.

### COMPARATIVE EXAMPLE 1

Specimens were prepared in the same manner as Example 1, except for using BCPP4 instead of BCPP1. Then, their physical properties were measured. The results are shown in Table 2.

### COMPARATIVE EXAMPLE 2

Specimens were prepared in the same manner as Example 1, except for using BCPP5 instead of BCPP1. Then, their physical properties were measured. The results are shown in Table 2.

### COMPARATIVE EXAMPLE 3

Specimens were prepared in the same manner as Example 1, except for using BCPP6 instead of BCPP1. Then, their physical properties were measured. The results are shown in Table 2.

TABLE 2

| | Example | | | Comparative Example | | |
|---|---|---|---|---|---|---|
| | 1 | 2 | 3 | 1 | 2 | 3 |
| | Block copolymer | | | | | |
| | BCPP1 | BCPP2 | BCPP3 | BCPP4 | BCPP5 | BCPP6 |
| MFR | 31.7 | 17.8 | 21.9 | 25.2 | 53.6 | 32.4 |
| (g/10 min) | | | | | | |
| FM (MPa) | 909 | 742 | 804 | 757 | 1061 | 874 |
| IZOD impact | | | | | | |
| strength | | | | | | |
| (kJ/m²) | | | | | | |
| 23° C. | 16.7 | 62.1 | 57.5 | 28.8 | 8.0 | 14.2 |
| −30° C. | 4.9 | 7.6 | 6.4 | 6.1 | 3.5 | 5.0 |
| UE (%) | 402 | 507 | 361 | 360 | 36 | 18 |
| Die swell | 1.47 | 1.51 | 1.42 | 1.33 | 1.27 | 1.41 |

### EXAMPLE 4

### Preparation of Injection Molded Article

To 82 parts by weight of the pellets of BCPP2 used in Example 2 and 18 parts by weight of homopolypropylene having an [η] of 0.90, 0.05 parts by weight of calcium stearate (produced by NOF Corp.), 0.10 parts by weight of 3,9-bis[2-{3-(3-tert-butyl-4-hydroxy-5-methylphenyl) propionyloxy}-1,1-dimethylethyl]-2,4,8,10-tetraoxaspiro [5.5]undecane (SUMILIZER GA80, produced by Sumitomo Chemical Co., Ltd.), and 0.20 parts by weight of 6-[3-(3-tert-butyl-4-hydroxy-5-methylphenyl) propoxy]-2,4,6,8,10-tetra-tert-butyldibenz[d,f][1.3.2] dioxaphosphepine (SUMILIZER GP, produced by Sumitomo Chemical Co., Ltd.) as stabilizers were added, followed by pelletization using a twin screw extruder (15φ twin screw extruder produced by Technovel Corp., Ltd., cylinder temperature=200° C.). Some of the pellets obtained were injection molded by an injection molding machine (IS100EN produced by Toshiba Machine Co., Ltd., cylinder temperature=200° C.) into specimens. The physical properties of the specimens were measured. The tensile rate in the tensile test was 50 mm/min (first injection molding). In the first injection molding, the residence time of the molding material in the cylinder of the injection molding machine was not longer than 2 minutes. Separately from the first injection molding, specimen were prepared by injection molding (second injection molding) following a 20-minute residence of a molten resin in a cylinder at 200° C. A tensile test was conducted at a tensile rate of 50 mm/min. The results are shown in Table 3.

### EXAMPLE 5

Specimens were prepared and their physical properties were measured in the same manner as Example 4, except for using 100 parts by weight of pellets of BCPP3 instead of the pellets of BCPP2 and failing to use the homopolypropylene having an [η] of 0.90. The results are shown in Table 3.

### COMPARATIVE EXAMPLE 4

Specimens were prepared and their physical properties were measured in the same manner as Example 4, except for using 89 parts by weight of pellets of BCPP4 instead of the pellets of BCPP2 and using 11 parts by weight of the homopolypropylene having an [η] of 0.90. The results are shown in Table 3.

### COMPARATIVE EXAMPLE 5

Specimens were prepared and their physical properties were measured in the same manner as Example 4, except for using 94 parts by weight of pellets of BCPP5 instead of the pellets of BCPP2 and using 6 parts by weight of a homopolypropylene having an [η] of 0.87 instead of the homopolypropylene having an [η] of 0.90. The results are shown in Table 3.

TABLE 3

| | | | Comparative | |
|---|---|---|---|---|
| | Example | | Example | |
| | 4 | 5 | 4 | 5 |
| Block copolymer | BCPP2 | BCPP3 | BCPP4 | BCPP5 |
| MFR (g/10 min) | 28.5 | 23.1 | 32.2 | 36.1 |
| FM (MPa) | 933 | 844 | 882 | 1025 |
| IZOD impact strength (kJ/m²) | | | | |
| 23° C. | 13.6 | 57.0 | 15.8 | 10.4 |
| −30° C. | 4.3 | 5.5 | 4.4 | 4.3 |
| UE (%) | 276 | 174 | 141 | 60 |
| UE after 20-minute residence (%) | 94 | 93 | 65 | 22 |

The experimental results shown in Tables 2 and 3 show that the propylene-ethylene block copolymers of Examples 1 to 5 are excellent in impact resistance, elongation, heat resistance and moldability.

It is also shown that the propylene-ethylene block copolymers of Comparative Eamples 1 to 5 are unsatisfactory either in impact resistance, elongation, heat resistance or moldability.

### INDUSTRIAL APPLICABILITY

The propylene-ethylene block copolymer of the present invention can be molded into molded articles by appropriate methods. It is suitable particularly for injection molding. Molded articles containing the propylene-ethylene block copolymer of the present invention are excellent in stiffness, toughness, impact resistance, and the like. Therefore, for example, injection molded articles produced from the propylene-ethylene block copolymer of the present invention are suitable as automotive components, such as door trims, pillars, instrument panels and bumpers.

1. A propylene-ethylene block copolymer comprising from 60 to 85% by weight, based on the total amount of the propylene-ethylene block copolymer, of a polypropylene portion which is a propylene homopolymer or a copolymer of propylene with 1 mol % or less of comonomer selected from ethylene or α-olefins having 4 or more carbon atoms, and from 15 to 40% by weight, based on the total amount of the propylene-ethylene block copolymer, of a propylene-ethylene random copolymer portion having a weight ratio of propylene units to ethylene units of from 35/65 to 75/25, wherein the propylene-ethylene block copolymer satisfies the following requirements (1) and (2):
requirement (1): the propylene-ethylene random copolymer portion comprises a first propylene-ethylene random copolymer component (EP-A) and a second propylene-ethylene random copolymer component (EP-B), the first copolymer component (EP-A) having an intrinsic viscosity [η]_{EP-A} of not less than 4 dl/g but less than 8 dl/g and an ethylene content [(C2′)_{EP-A}] of from 20 to 60% by weight, and the second copolymer component (EP-B) having an intrinsic viscosity [η]_{EP-B} of not less than 0.5 dl/g but less than 3 dl/g and an ethylene content [(C2′)_{EP-B}] of from 40 to 80% by weight,
requirement (2): the propylene-ethylene block has a melt flow rate of from 5 to 120 g/10 min.

2. The propylene-ethylene block copolymer according to claim 1, wherein the ethylene content [(C2′)_{EP-A}] is from 25 to 45% by weight and the ethylene content [(C2′)_{EP-B}] is from 42 to 60% by weight.

3. The propylene-ethylene block copolymer according to claim 1, wherein the crystalline polypropylene portion has an intrinsic viscosity [η]_{P} of 1.5 dl/g or less and a molecular weight distribution, as measured by gel permeation chromatography, of not less than 3 but less than 7.

4. A molded article comprising the propylene-ethylene block copolymer according to any one of claims 1 to 3.
